(19) United States
(12) Patent Application Publication
(10) Pub. No.: US 2016/0100918 A1
(43) Pub. Date: Apr. 14, 2016

(54) PROCESS FOR THE FORMATION OF DENTAL PROSTHESES AND/OR SUPPORT STRUCTURES FOR DENTAL PROSTHESES, SUCH AS BRIDGES AND/OR THE LIKE, PROCESS FOR MAKING DENTAL WAFERS AND/OR SIMILAR STRUCTURES AND DENTAL WAFER FOR THE FORMATION OF DENTAL PROSTHESES

(71) Applicant: MICRO.MEDICA S.r.l., PALESTRO (PV) (IT)

(72) Inventors: Giuseppe CIRRONIS, PALESTRO (PV) (IT); Alessandra PADERNO, PALESTRO (PV) (IT)

(21) Appl. No.: 14/878,146

(22) Filed: Oct. 8, 2015

(30) Foreign Application Priority Data
Oct. 10, 2014 (IT) MI2014A001780

(51) Int. Cl. A61C 13/00; A61C 13/09

(52) U.S. Cl. CPC A61C 13/0022; A61C 13/09

(57) ABSTRACT

A process (100) for the formation of dental prostheses (1) and/or support structures therefor comprises making (101) a dental wafer (1) and removing (102) a predefined quantity of material, according to a three-dimensional reference model, from such a dental wafer (1). The making step comprises overlapping (101a) two or more layers of formation (2a), pre-imbued or to be imbued with thermosetting resin or a thermoplastic resin, wherein at least one of the layers of formation (2a) comprises graphene and/or carbon fibre and/or glass fibre; compressing (101b) one layer of formation (2a) against the other to join these and break any micro air bubbles present; heating (101c) the layers of formation (2a) to harden them and form the dental wafer (1) and finish the wafer (1). A process is also described for making dental wafers (1) and a dental wafer (1) that comprises graphene.

The present invention refers to a process for the formation of dental prostheses.

Another object of the present invention is a process for making wafers and/or similar structures, in particular for the formation of dental prostheses and/or of support structures for dental prostheses, such as bridges and/or similar.

Another object of the present invention is a dental wafer and/or a similar structure for the formation of dental prostheses, in particular on material removal CNC centres and/or machines.

The present invention is suitable for being used in the field of dentistry and/or orthodontics and, in particular, it refers to dental prostheses intended to partially and/or totally replace the natural dental arches of patients and/or to support structures of such prostheses, like for example bridges and/or similar.

In detail, the present invention refers to dental wafers and/or to dental tablets and/or to similar structures, called in the field by the technical term “pre-forms” or “high-density pre-forms”, intended for apparatuses for the formation of dental prostheses that operate by removal of material, like for example pantographs or CNC CAD-CAM centres and/or machines.

Generally, dental wafers are monolithic elements of substantially disc-shaped configuration from which it is possible to obtain, by removal of material, dental prostheses, bridges and/or circular, semi-circular and/or arched structures.

Among the various dental wafers that can be found on the market there are wafers made of zirconium, polymethyl methacrylate (Pmma) and modelling wax and similar.

However, it should be noted that it is not possible to obtain or form a high-performance dental prosthesis, in other words having high mechanical strength, hardness, solidity and lightness, from the aforementioned wafers. The Applicant has found that the wafers spread on the market are made through materials that cannot give them high performance in relation to mechanical strength, hardness, solidity and lightness.

The main purpose of the present invention is to solve the problems encountered in the prior art.

A purpose of the present invention is to provide dental prostheses and/or support structures for dental prostheses having high mechanical strength.

A further purpose of the present invention is to propose dental prostheses and/or support structures for dental prostheses having high hardness.

Another purpose of the present invention is to provide a dental prosthesis and/or support structures for dental prostheses that is particularly solid.

A further purpose of the present invention is to propose a dental prosthesis and/or support structures for dental prostheses that is rather light.

Another purpose of the present invention is to provide dental wafers and/or similar structures from which it is possible to obtain, by removal of material, dental prostheses and/or support structures for dental prostheses having high mechanical strength, hardness, solidity and lightness.

The purposes specified above, and others still, are substantially accomplished by a process for the formation of dental prostheses and/or support structures for dental prostheses, a process for making wafers and/or similar structures, in particular for the formation of dental prostheses and/or support structures for dental prostheses, such as bridges and/or similar, as well as a dental wafer and/or a similar structure for the formation of dental prostheses, in particular on material removal CNC centres and/or machines, as expressed and described in the following claims.

Now follows, as an example, the description of a preferred, but not exclusive embodiment of a process for the formation of dental prostheses and/or support structures for dental prostheses, of a process for making wafers and/or similar structures, in particular for the formation of dental prostheses and/or support structures for dental prostheses, such as bridges and/or similar, as well as of a dental wafer and/or a similar structure for the formation of dental prostheses, in particular on material removal CNC centres and/or machines, in accordance with the present invention.

The description will be made hereafter with reference to the attached drawings, provided only for indicating and therefore not limiting purposes, in which:

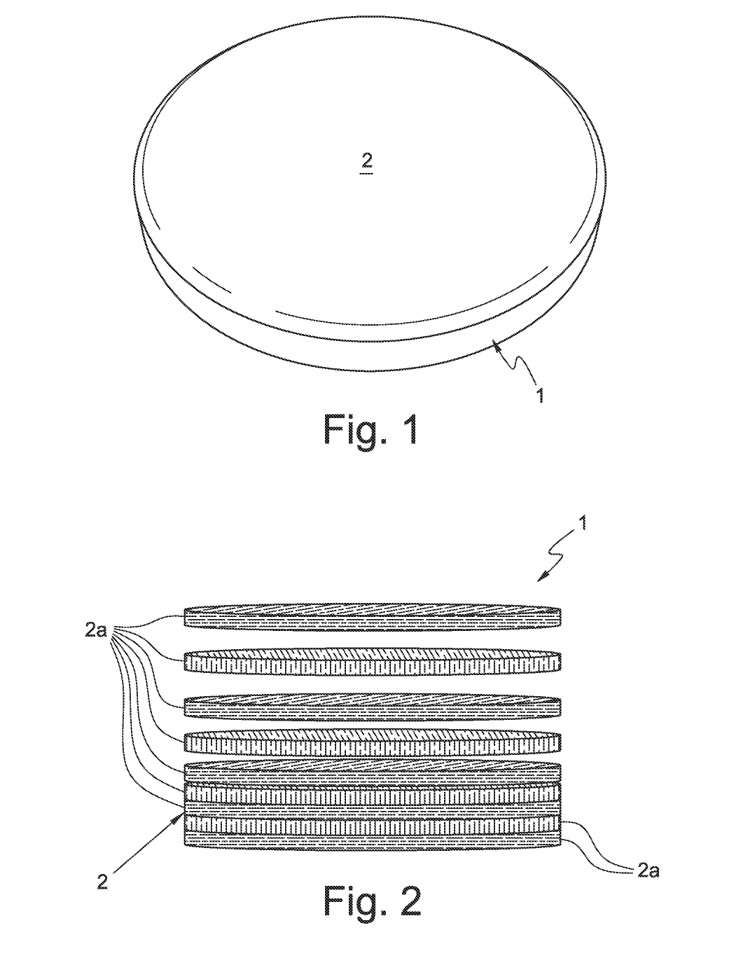

FIG. 1 is a perspective view of a dental wafer and/or a similar structure for the formation of dental prostheses, in particular on material removal CNC centres and/or machines, in accordance with the present invention;

FIG. 2 is a schematic representation of the layers of formation of the body of the dental wafer according to FIG. 1;

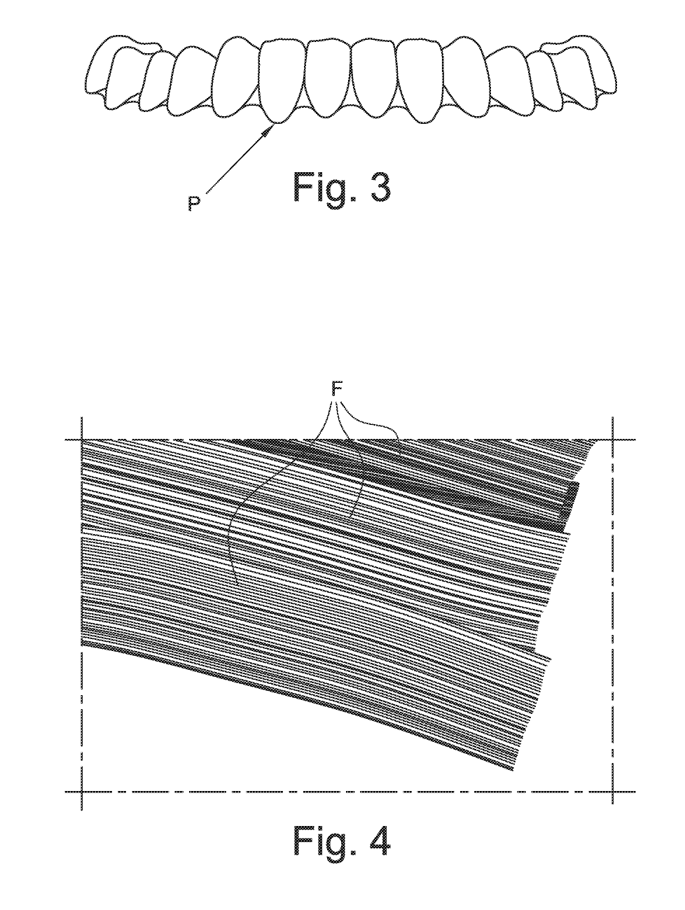

FIG. 3 is a schematic representation of a dental prosthesis obtained, by removal of material, from the dental wafer according to FIGS. 1 and 2;

FIG. 4 is a schematic representation of a sheet provided with graphene, carbon or glass fibres arranged unidirectionally;

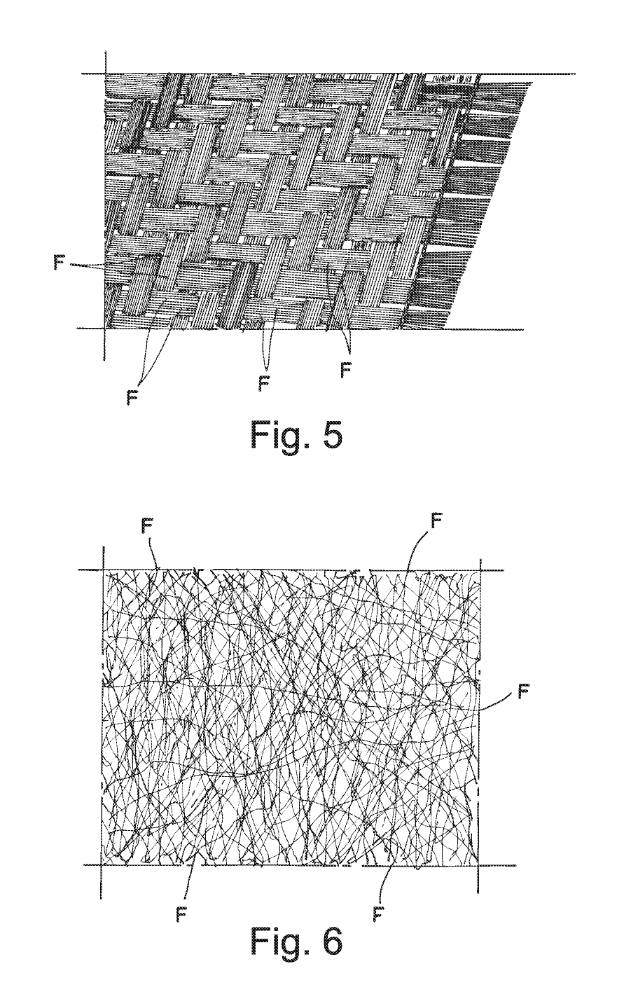

FIG. 5 is a schematic representation of a sheet provided with graphene, carbon or glass fibres arranged bidirectionally, in particular orthogonal to one another;

FIG. 6 is a schematic representation of a sheet provided with graphene, carbon or glass fibres arranged multidirectionally to one another;

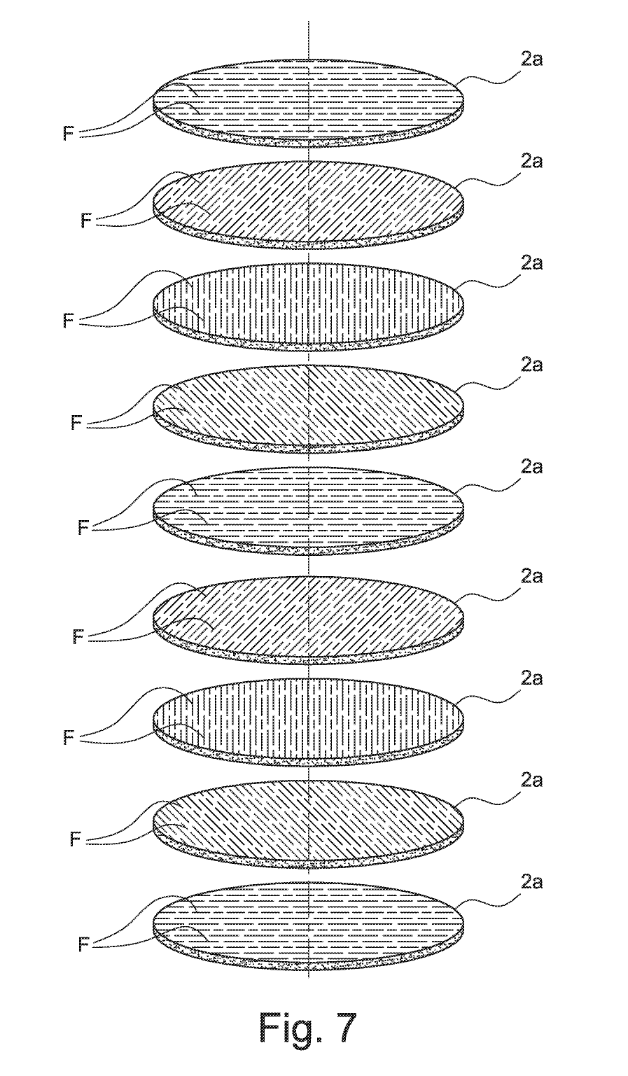

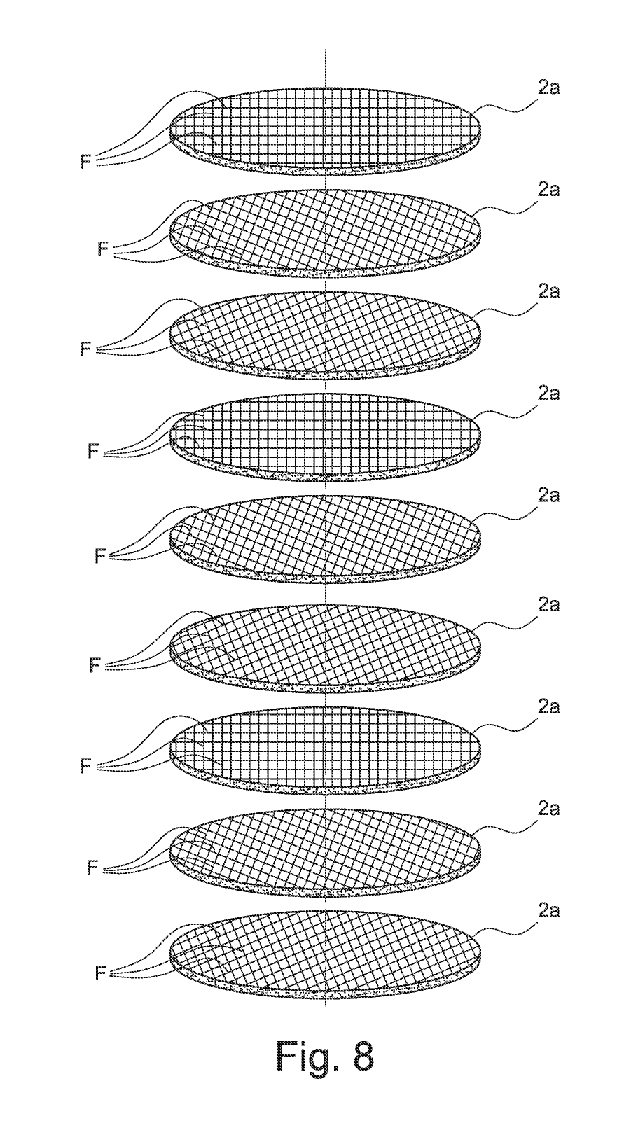

FIGS. 7 and 8 are a schematic representation of the overlapping of the layers of formation of the dental wafer according to FIGS. 1 and 2;

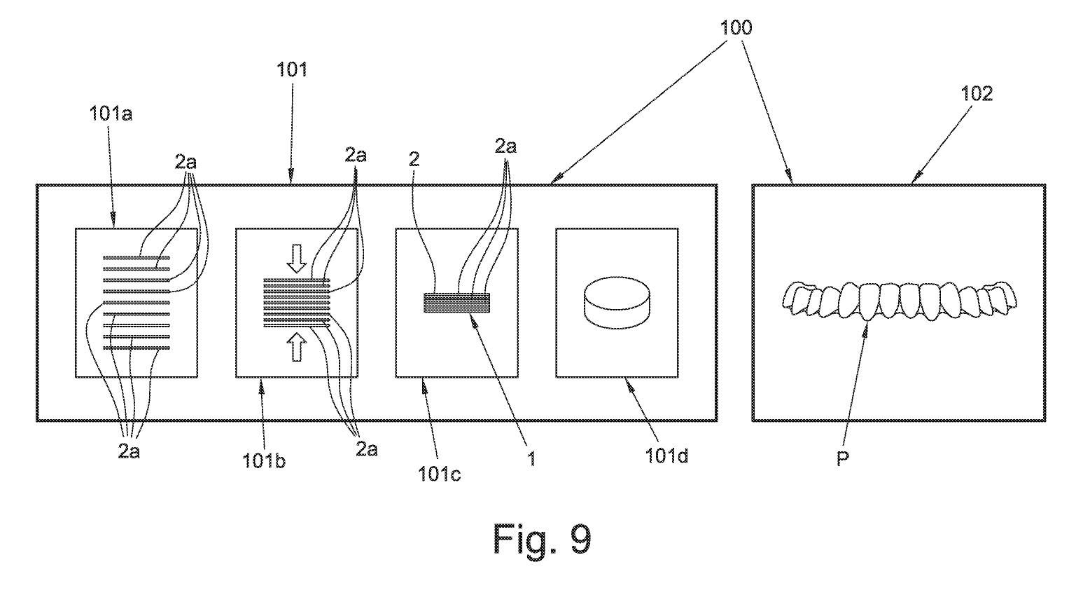

FIG. 9 is a schematic representation of a process for the formation of dental prostheses and/or support structures for dental prostheses, in accordance with the present invention;

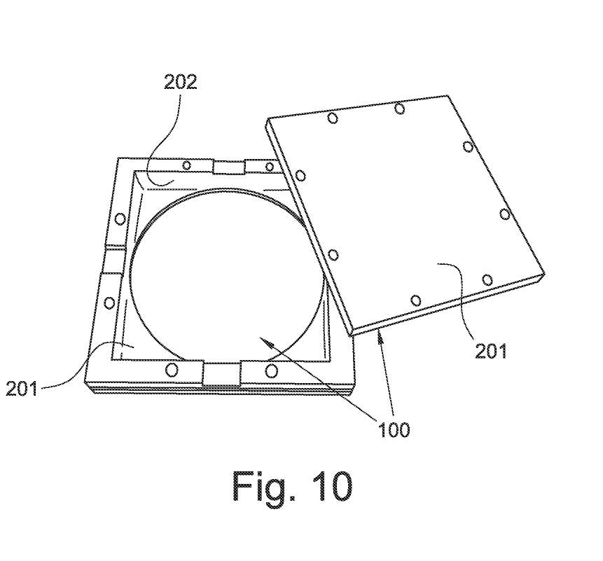

FIG. 10 is a representation of a mould that can be used in the process according to the block diagram of FIG. 9 for making the dental wafers according to FIGS. 1 and 2.

With reference to FIGS. 1 and 2, reference numeral 1 wholly indicates a dental wafer and/or a similar structure for dental prostheses P, in particular on material removal CNC centres and/or machines, in accordance with the present invention.

The dental wafer 1 comprises a body 2 having a substantially cylindrical configuration, preferably disc-shaped (FIG. 1).

However, it should be noted that for the purposes of the present invention the body 2 of the dental wafer 1 can also have a cubic, parallelepiped or prismatic configuration.

Going into detail, the body 2 of the dental wafer 1 is provided with at least two layers of formation 2a (FIG. 2), in particular a plurality of layers of formation 2a, overlapping one another.

Advantageously, at least one of the layers of formation 2a of the body 2 of the dental wafer 1 comprises graphene and/or carbon fibre and/or glass fibre.

Advantageously, at least one of the layers of formation 2a of the body 2 of the dental wafer 1 comprises graphene and/or sheeted graphene, the thickness of which is comprised between 0.2μ and 250μ, preferably between 0.5μ and 200μ and/or graphene fibre and/or graphene particles of various forms, with maximum dimensions comprised between 0.2μ and 300μ, preferably 0.5μ and 20μ and/or a resin doped with graphene particles of various forms, with maximum dimensions comprised between 0.2μ and 300μ, preferably 0.5μ and 20μ.

In accordance with a preferred embodiment of the present invention, each layer 2a of the body 2 of the dental wafer 1 comprises graphene and/or sheeted graphene and/or graphene fibre and/or graphene particles and/or a resin doped with graphene particles. In accordance with a further embodiment of the present invention, at least one of the layers of formation 2a of the body 2 of the dental wafer 1, preferably more than one, comprises carbon fibre, in particular in sheet, in which each fibre has a diameter comprised between 1μ and 15μ, preferably between 3μ and 8μ, and/or a resin doped with carbon fibres, in which each fibre has a diameter comprised between 1μ and 15μ, preferably between 3μ and 8μ, and/or particles of carbon fibre of various forms the maximum dimensions of which are comprised between 0.1 mm and 12 mm, preferably between 0.1 mm and 6 mm.

In accordance with a preferred embodiment of the present invention, each layer 2a of the body 2 of the dental wafer 1 comprises carbon fibre in sheet and/or in resin and/or particles of carbon fibre dispersed in a resin.

In accordance with a further embodiment of the present invention, at least one layer of formation 2a in carbon fibre, preferably more than one, of the body 2 of the dental wafer 1 comprises glass fibre, in which each fibre has a diameter comprised between 1μ and 15μ, preferably between 3μ and 8μ, in particular in sheet, and/or a resin doped with glass fibre, in which each fibre has a diameter comprised between 1μ and 15μ, preferably between 3μ and 8μ, and/or particles of glass fibre of various forms the maximum dimensions of which are comprised between 0.1 mm and 12 mm, preferably between 0.1 mm and 6 mm.

In accordance with a preferred embodiment of the present invention, each layer 2a of the body 2 of the dental wafer 1 comprises glass fibre in sheet and/or in resin and/or particles of carbon fibre dispersed in a resin.

Therefore, the dental wafer 1 described above can be made totally with graphene or carbon fibre or glass fibre, just as it can be made using such materials in combination. For example, it is possible to provide that the body 2 of the dental wafer 1 be formed from some layers of formation 2a in graphene and from some layers of formation 2a in carbon fibre.

Alternatively, it is possible to provide for the body 2 of the dental wafer 1 to be formed from some layers of formation 2a in graphene and from some layers of formation 2a in glass fibre.

It is also possible to provide for the body 2 of the dental wafer 1 to be provided with some layers of formation 2a in carbon fibre and others in glass fibre. It is not excluded that the body 2 of the dental wafer 1 also be provided with some layers of formation 2a in graphene, some layers of formation 2a in carbon fibre and other layers of formation 2a in glass fibre suitably coupled to each other.

The arrangement of the layers of formation 2a, understood as the layered sequence of the different materials used, can vary according to requirements and is selected as a function of the type of dental prostheses P (FIG. 3) that it is wished to make.

Advantageously, the layers of formation 2a of the body 2 of the dental wafer 1 provided with graphene, carbon or glass fibres can have fibres F oriented unidirectionally (FIG. 4), bidirectionally (FIG. 5), for example transversely or orthogonally, or multidirectionally (FIG. 6).

According to an advantageous aspect of the present invention, schematically represented in FIGS. 7 and 8, the layers of formation 2a of the body 2 of the dental wafer 1 are arranged in such a way that the graphene and/or carbon and/or glass fibres F of at least one of the layers of formation 2a are oriented transversely with respect to the fibres of another layer of formation 2a overlapping it, in such a way that the overall structure consists of a multitude of fibres F, on several overlapped layers of formation 2a, which cross each other and intersect to define a sort of resistant mesh.

The present invention also provides a process 100, schematically represented in blocks in FIG. 9, for the formation of dental prostheses P (FIG. 3) and/or of analogous dental structures, such as bridges and/or similar.

In particular, as can be seen in the block diagram of FIG. 9, the process 100 comprises the preliminary step of making 101 at least one dental wafer 1 (FIGS. 1 and 2) or a similar structure for dental works, such as the formation of dental prostheses P and/or bridges and/or similar.

Preferably, the dental wafer 1 obtained through the step of making 101 of the process 100 is intended for CNC CAD-CAM numerical control centres and/or machines through which it is possible to carry out the formation of the dental prostheses P by removal of material based on three-dimensional reference models.

In detail, the step of making 101 the dental wafer 1 is preferably carried out by firstly carrying out a step of overlapping 101a at least two layers of formation 2a, preferably a plurality of layers of formation 2a, pre-imbued or to be imbued with at least one thermosetting resin, such as an epoxy, acrylic, vinyl ester or polyester resin, or a thermoplastic resin, like for example polyamide and peek, in which at least one of the layers of formation 2a, preferably two or more, comprises graphene and/or carbon fibre and/or glass fibre in the most appropriate forms.

Once the step of overlapping 101a the layers of formation 2a has ended, a step of compressing 101b one layer of formation 2a against the other 2a is carried out to join these latter and break any micro air bubbles present therein or in the resins used to imbue them.

At the end of the compression step 101b a step of heating 101c the layers of formation 2a is carried out so that these latter harden forming a respective dental wafer 1 provided with graphene.

Subsequently to the step of making 101 the dental wafer 1, the process 100 comprises a step of removing 102 a predefined quantity of material. The removing step is preferably carried out starting from the dental wafer 1 based on a suitable three-dimensional reference model stored on a suitable memory support to form, at least in part, the dental prosthesis P and/or the support structure to be made.

The step of overlapping 101a the layers of formation 2a is carried out through the use of sheets of graphene and/or carbon and/or glass fibre F and provides, in detail, overlapping sheets the fibres F of which can be oriented unidirectionally or bidirectionally, preferably perpendicularly, or multidirectionally.

The step of overlapping 101a the aforementioned layers of formation 2a provides that each sheet be overlapped to at least one other sheet so that the respective fibres F are oriented transversely with respect to the fibres F of this latter. In other words, the step of overlapping 101a the aforementioned layers of formation 2a is carried out by firstly arranging a first sheet of fibres F so that these latter are oriented according to a respective reference direction, overlapping a second sheet with the respective fibres oriented transversely with respect to the fibres F of the first sheet, and subsequently each sheet so that the fibres F of this latter are oriented transversely with respect to the fibres F of the sheet overlapped previously.

Preferably, at least the steps of overlapping 101a and compressing 101b the layers of formation 2a can be carried out in a mould 200 (FIG. 10) provided with two shells 201 that define a housing space 202 adapted to receive the aforementioned layers of formation 2a.

Alternatively, the steps of overlapping 101a and compressing 101b the layers of formation 2a can also be carried out through the help of a vacuum bag in autoclave.

The heating step 101c can also be carried out in the mould 200 or in a suitable oven, once the compressed layers have been extracted from the mould 200 or from the vacuum bag in autoclave.

Subsequently to the step of heating 101c and to the consequent hardening of the compressed layers of formation 2a, the process 100 also comprises a finishing step 101d (FIG. 9), preferably by removal of material, which defines the definitive shape of the dental wafer 1 to be subjected to the step of removal 102 for the formation of said dental prosthesis P.

The present invention also comprises a process for making dental wafers 1 and/or similar structures that comprises the steps of overlapping 101a, compressing 101b, heating 101c and finishing 101d of the process 100 for the formation of dental prostheses P schematically illustrated in FIG. 9.

The invention solves the problems encountered in the prior art and achieves important advantages.

The dental wafers according to the present invention obtained through the process described above allow dental prostheses to be made having high mechanical strength, hardness, solidity and lightness.

1. Process for the formation of dental prostheses, support structures for dental prostheses, such as bridges and the like, comprising the following steps:
making at least one dental wafer or a similar structure for dental works, such as the formation of dental prostheses or of support structures for dental prostheses, in particular for CNC numerical control centres or machines responsible for the formation of dental prostheses by removal of material;
removing a predefined quantity of material, preferably according to a three-dimensional reference model, from the dental wafer to form, at least in part, a dental prosthesis or a support structure;
the step of making the dental wafer comprising the steps of:
overlapping at least two layers of formation, preferably a plurality of layers of formation, pre-imbued or to be imbued with at least one thermosetting resin or one thermoplastic resin, wherein at least one of the layers of formation comprises graphene and/or carbon fibre and/or glass fibre;
compressing a layer of formation against the other to join these latter and break any micro air bubbles present therein;
heating the layers of formation to harden these latter and form the dental wafer provided with graphene.

2. Process for making dental wafers or similar structures, in particular for dental works, such as the formation of dental prostheses or of support structures for dental prostheses, said process comprising the steps of:
overlapping at least two layers of formation, preferably a plurality of layers of formation, pre-imbued or to be imbued with at least one thermosetting resin or one thermoplastic resin, wherein at least one of the layers of formation comprises graphene and/or carbon fibre and/or glass fibre;
compressing a layer of formation against the other to join these latter and break any micro air bubbles present therein;
heating the layers of formation to harden these latter and form the dental wafer provided with graphene.

3. Process according to claim 1, wherein the graphene is present in the dental wafer in the form of sheets and/or in the form of fibres and/or in the form of particles dispersed in a resin, preferably a thermosetting or thermoplastic resin.

4. Process according to claim 1, wherein the carbon fibre is present in the dental wafer in the form of sheets and/or in a resin, preferably a thermosetting or thermoplastic resin, and/or in the form of fibre particles dispersed in a resin, preferably a thermosetting or thermoplastic resin.

5. Process according to claim 1, wherein the glass fibre is present in the dental wafer in the form of sheets and/or in a resin, preferably a thermosetting or thermoplastic resin, and/or in the form of glass fibre particles dispersed in a resin, preferably a thermosetting or thermoplastic resin.

6. Process according to claim 3, wherein each sheet of graphene fibre is provided with fibres oriented unidirectionally or perpendicularly or multidirectionally, the sheets being overlapped on each other or on the layers of formation in resin and being arranged in such a way that the respective fibres are oriented transversely with respect to the fibres of the other sheets.

7. Process according to claim 4, wherein each sheet of carbon fibre is provided with fibres oriented unidirectionally or perpendicularly or multidirectionally, the sheets being overlapped on each other or on the layers of formation in resin and being arranged in such a way that the respective fibres are oriented transversely with respect to the fibres of the other sheets.

8. Process according to claim 5, wherein each sheet of glass fibre is provided with fibres oriented unidirectionally or perpendicularly or multidirectionally, the sheets being overlapped on each other or on the layers of formation in resin and being arranged in such a way that the respective fibres are oriented transversely with respect to the fibres of the other sheets.

9. Process according to claim 1, wherein the overlapping of said layers of formation is carried out in a mould or in a vacuum bag in autoclave, the process also comprising a finishing step, by removal of material, subsequent to the heating step.

10. Dental wafer or similar structure for the formation of dental prostheses, in particular on material removal CNC centres or machines, comprising a body provided with at least two layers of formation, in particular a plurality of layers of formation, wherein at least one of the layers of formation comprises graphene and/or carbon fibre and/or glass fibre.

11. Dental wafer according to claim 10, wherein at least one of the layers of formation of the body of the dental wafer comprises graphene fibre in the form of a sheet and/or in the form of particles dispersed in a resin, preferably a thermosetting or thermoplastic resin.

12. Dental wafer according to claim 10, wherein at least one of the layers of formation of the body of the dental wafer comprises carbon fibre in the form of sheets and/or in a resin, preferably a thermosetting or thermoplastic resin, and/or in the form of fibre particles dispersed in a resin, preferably a thermosetting or thermoplastic resin.

13. Dental wafer according to claim 10, wherein at least one of the layers of formation of the body of the dental wafer comprises glass fibre in the form of sheets and/or in a resin, preferably a thermosetting or thermoplastic resin, and/or in the form of glass fibre particles dispersed in a resin, preferably a thermosetting or thermoplastic resin.

14. Dental wafer according to claim 11, wherein the fibres of at least one of the layers of formation of the body of the dental wafer are oriented transversely with respect to the fibres of another layer of formation overlapped thereon.
